(19) United States
(12) Patent Application Publication
(10) Pub. No.: US 2026/0129404 A1
(43) Pub. Date: May 7, 2026

(54) USER-TO-DEVICE ASSOCIATION TRACKING SYSTEMS AND METHODS

(71) Applicants: AT&T Intellectual Property I, L.P., Atlanta, GA (US); AT&T Technical Services Company, Inc., Vienna, VA (US)

(72) Inventors: Michael Gonzales, Austin, TX (US); Yupeng Jia, South Pasadena, CA (US); Joseph Soryal, Glendale, NY (US); Daniel Vivanco, Ashburn, VA (US); Ari Craine, Marietta, GA (US); Adrianne Binh Luu, Atlanta, GA (US); Robert Moton, JR., Alpharetta, GA (US); Robert Koch, Norcross, GA (US)

(73) Assignees: AT&T Intellectual Property I, L.P., Atlanta, GA (US); AT&T Technical Services Company, Inc., Vienna, VA (US)

(21) Appl. No.: 18/939,087

(22) Filed: Nov. 6, 2024

(51) Int. Cl. H04W 4/029; G06Q 50/26

(52) U.S. Cl. CPC H04W 4/029; G06Q 50/265

(57) ABSTRACT

Aspects of the subject disclosure may include, for example, user-to-device association tracking systems and methods. A physical association of a user with a user device is determined, tracked, and recorded in a device association database via a device association server. The device association database records at least a user identification, a user device location, an association status, and an association reason. The association reason records information indicative of a context where the physical association between the user and the user device takes place. One or more sensors arranged to sense users and user devices can be registered in the device association database and provide an additional layer of information supplementing or enhancing the physical association of users with user devices. Other embodiments are disclosed.

### FIELD OF THE DISCLOSURE

The subject disclosure relates to user-to-device association tracking systems and methods.

### BACKGROUND

It is often useful to understand when and if a device is physically associated with its user, that is, whether the user has the device on their person, is wearing it, is carrying it, has it in a container nearby, or is touching it. This can be useful information, particularly in the case of an emergency situation when it may be necessary to understand not only the location of the device, but whether the location of the device is a true indication of the location of the user. Therefore, there is a need to be able to determine, track and use this physical association of a device with the user.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a sensor registration stage in accordance with various aspects described herein.

FIG. 2C is a block diagram illustrating an example, non-limiting embodiment of a device registration stage in accordance with various aspects described herein.

FIG. 2D is a block diagram illustrating an example, non-limiting embodiment of a device-user physical association stage including a touch association in accordance with various aspects described herein.

FIG. 2E is a block diagram illustrating another example, non-limiting embodiment of a device-user physical association stage including a facial association in accordance with various aspects described herein.

FIG. 2F is a block diagram illustrating an example, non-limiting embodiment of an association context in accordance with various aspects described herein.

FIG. 2G is a block diagram illustrating an example, non-limiting embodiment of a query/response for association status in accordance with various aspects described herein.

FIG. 2H depicts an illustrative embodiment of a method in accordance with various aspects described herein.

FIG. 2I depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for user-to-device association tracking systems and methods. In particular, a physical association of a user with a user device is determined, tracked, and recorded in a device association database via a device association server. The device association database records at least a user identification, a user device location, an association status, and an association reason. For instance, the association status includes various different types including TOUCH, CARRY, WORN, FACIAL, SPEECH, etc. The association reason records information indicative of a context where the physical association between the user and the user device takes place. For instance, the association reason includes a 911 call, a facial recognition, a finger print input, calling a virtual assistant, etc. One or more sensors arranged to sense users and user devices can be registered in the device association database and provide an additional layer of information supplementing or enhancing the physical association of users with user devices. Other embodiments are described in the subject disclosure.

One or more aspects of the subject disclosure are directed to a method including establishing, by a processing system including a processor, a device association database; registering, by the processing system, a target user device in the device association database; receiving, by the processing system, physical association detection data between a target user and the target user device; recording, by the processing system, the physical association detection data in an association status field of the device association database; receiving, by the processing system, a query regarding a location of the target user; and generating, by the processing system, a response to the query including the location of the target user device recorded in the device association database as the location of the target user.

One or more aspects of the subject disclosure are directed to a device including a processing system including a processor and a memory that stores executable instructions that, when executed by the processing system, facilitate performance of operations. The operations include registering a first type of user device including a location thereof and a second type of user device including a location thereof, respectively, in a device association database; receiving first physical association detection data between a first user and the first type of user device and second physical association detection data between a second user and the second type of user device; storing the first physical association detection data and the second physical association detection data in a device association database; providing, by the processing system, the location of the first type of user device recorded in the device association database as the location of the first user; and providing, by the processing system, the location of the second type of user device recorded in the device association database as the location of the second user.

One or more aspects of the subject disclosure are directed to a non-transitory machine-readable medium, comprising executable instructions that, when executed by a processing system including a processor, facilitate performance of operations. The operations include configuring a device association database to record a device ID, a user ID, a device location, a physical association status between a user and a device, and a device address; receiving, from a device association application running on the device, physical association detection data between the user and the device; dynamically updating the physical association status along with a timestamp updated with the receiving of the physical association detection data; and based on the recorded physical association status, transmitting the device location recorded in the device association database as a user location.

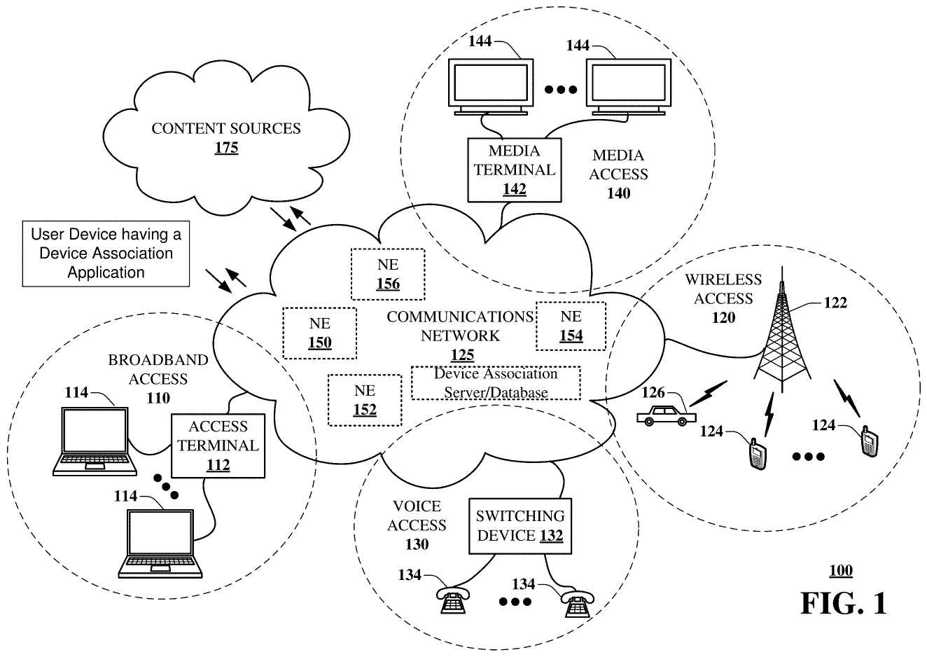

Referring now to FIG. 1, a block diagram is shown illustrating an example, non-limiting embodiment of a system 100 in accordance with various aspects described herein. For example, system 100 can facilitate in whole or in part user-to-device association tracking systems and methods. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

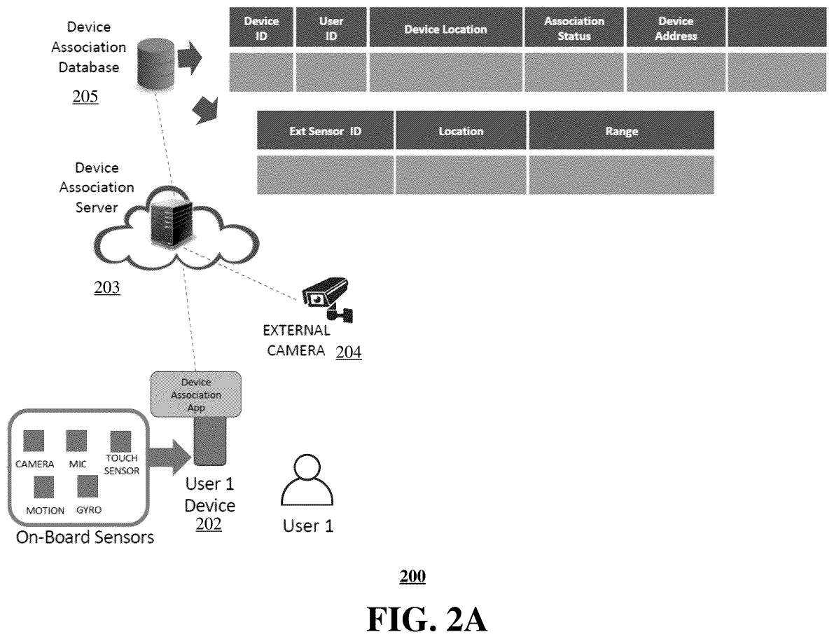

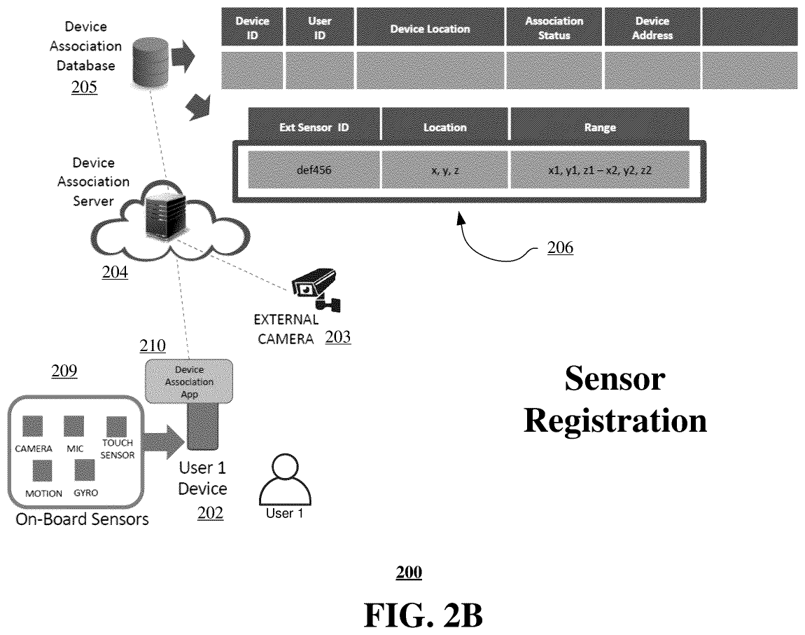

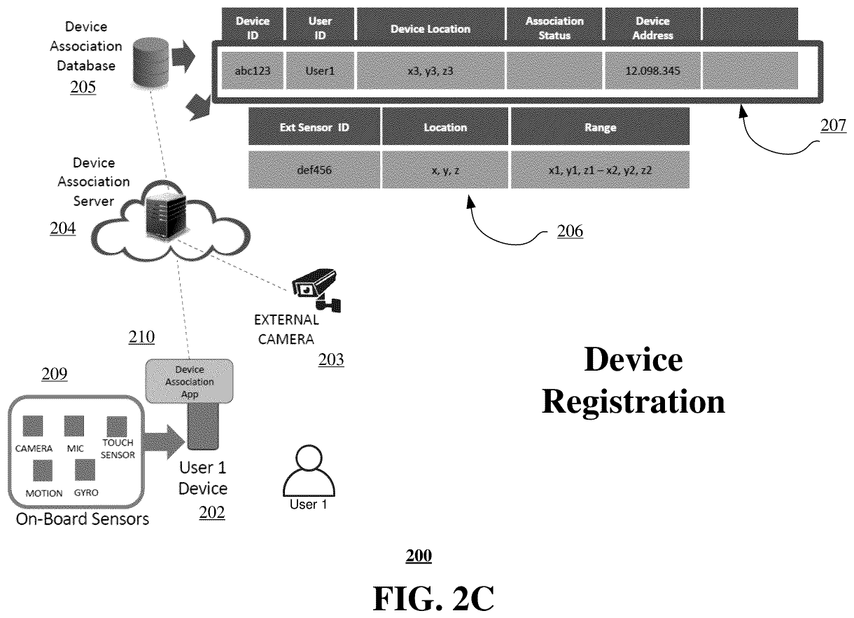

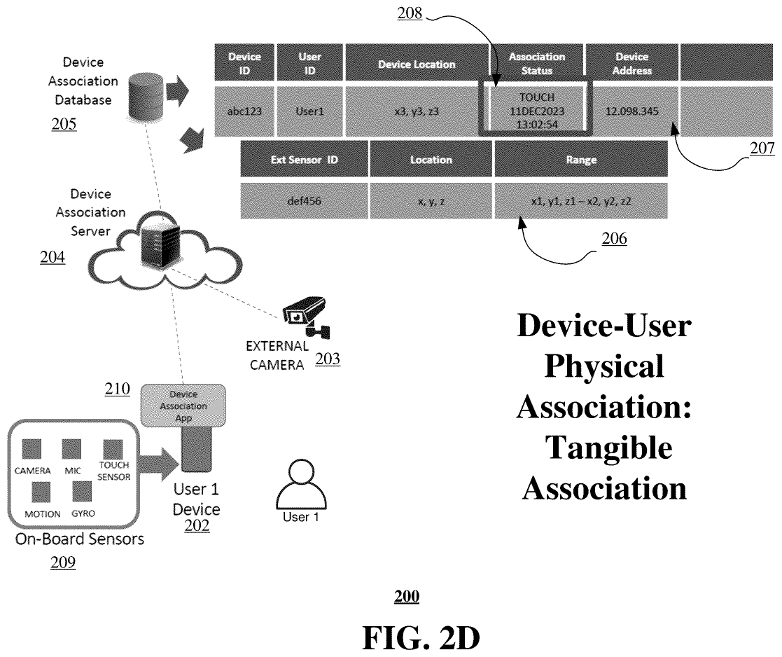

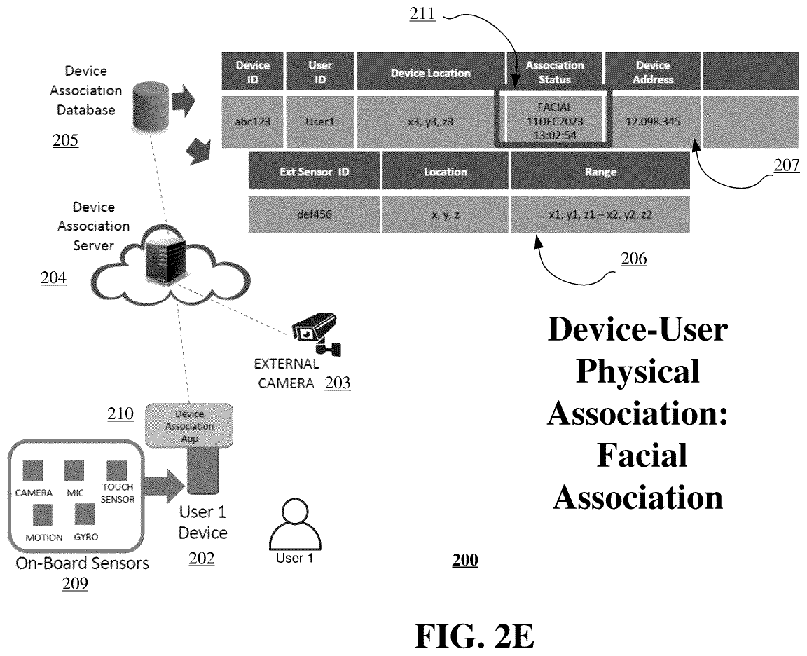

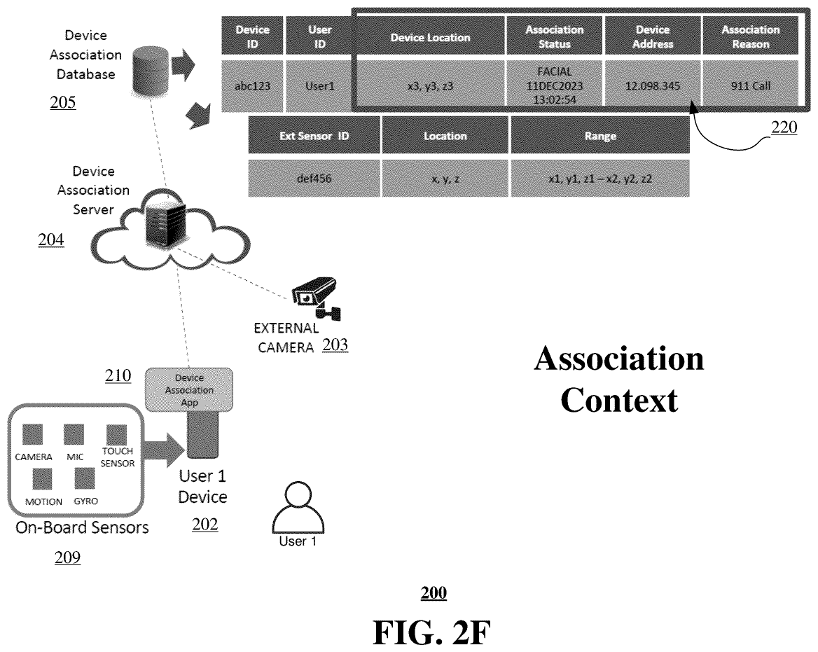

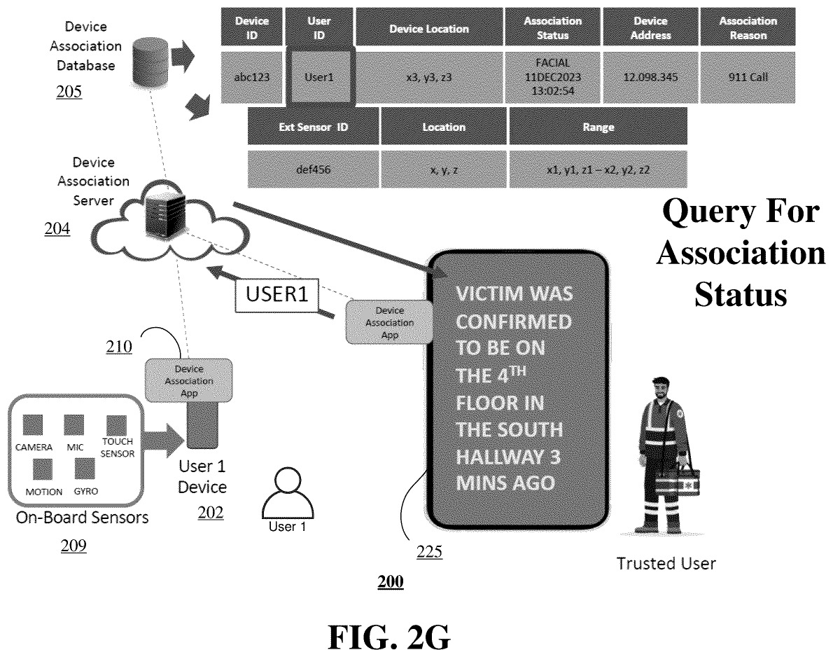

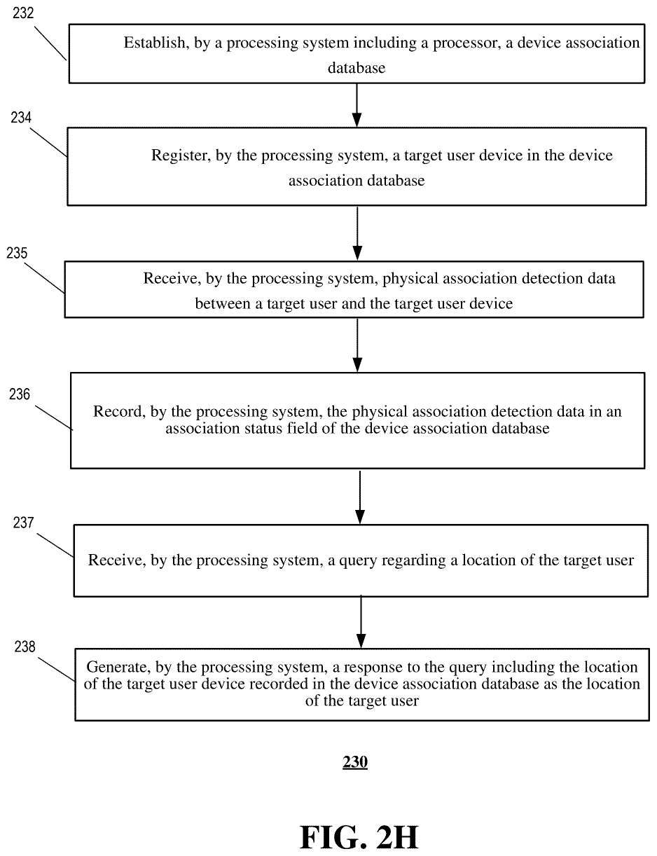

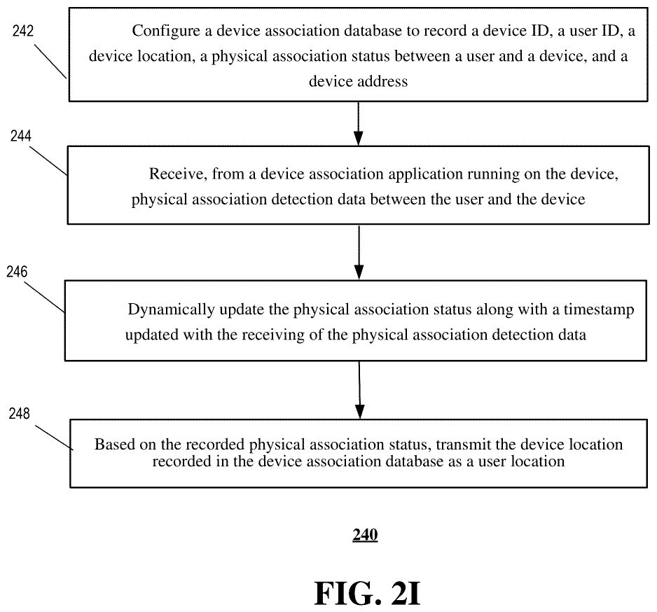

FIG. 2A is a block diagram illustrating an example, non-limiting embodiment of a system 200 functioning within the communication network of FIG. 1 in accordance with various aspects described herein. In various embodiments, the system 200 is configured to track and record a physical association of a user with a device. For example, it may be useful and important to be able to know whether a device is currently in the physical possession of a user—e.g., whether it is being held or worn by the user, or whether it is being carried by the user, such as in a pocket or container, such as a purse. This knowledge of physical association between a user and their device may be necessary, for example, to provide certain safety services, such as a true determination of the user's location—not just the location of their device. Users may be offered to select and opt in for using the user and device association as an additional layer of service when signing up for a wireless communications service. When users select and opt in for the user and device association service, then registered users'information can be used to establish the user and device association service to facilitate efficient implementation of such service.

In various embodiments, the system 200 can include hardware and/or software (which can include virtual functionality) for providing tracking and recording the physical association of the user with the device. As an example, a device association database 205 can be a single database or multiple databases. The device association database 205 can operate as a user database storing user information including but not limited to user ID data, user location data, user condition data, biometric ID data, physical access data, and/or communication access data. The device association database 205 can operate as a user access database storing other user information (e.g., associated with other users that may be granted a temporary relationship with a first user) including but not limited to other user ID data, other user location data, other user biometric ID data, and/or other user authorization level if needed. The device association database 205 can operate as a user relationships access database storing relationship permission information (e.g., associated with a relationship between a user and the other trusted user(s) that may result in sharing of location information) including but not limited to party ID data, physical access permission, and/or communication access permission. This various data can be managed and collected through the various techniques described herein, including in real-time, near-teal-time, frequently, according to a schedule, and/or according to polling.

In one or more embodiments, a device association server 203 can have access to or otherwise be in communication with various sensors 204 and 209 for collecting information associated with User 1, as well as collecting other information that facilitates tracking and recording the physical association of User 1 with the User 1 device 202 including environmental information, security information, images, audio, pressure, tactile, light, motion, temperature, and so forth. In one or more embodiments, one or more of the sensors 203 can be part of IoT device(s). In one or more embodiments, the device association server 204 can have access to or otherwise be in communication with various on-board sensors 209 for collecting information associated with User 1, as well as collecting other information that facilitates tracking and recording the physical association of User 1 and User 1 device including images, audio, location, motion, gyroscopic data and so forth. In one or more embodiments, software applications or device association applications can be resident on or accessible to (e.g., via a browser) UEs operating in the system 200, such as the User 1 device 202. In other embodiments, the sensor 204 can be part of equipment associated with a premises, including a WLAN, a home network, a security network, a building management system, and so forth.

In various embodiments, User 1 owns or uses a device 202 (i.e., User 1 Device) which can be a location-aware device. In FIGS. 2B through 2G, User 1 and the User 1 device 202 (“the device 202”) are described for convenience of explanation and the present disclosure is not limited thereto. The device 202 may be equipped with various sensors, such as a camera, a microphone, a touch sensor, a motion sensor, a gyroscope, or a combination thereof, by way of example only. A device association application 210 may be running on the device 202 and in communication with the device association server 203 over a network. The device association server 203 may be configured to run based on a subscription. Devices subscribed to the device association server 203 may communicate and exchange information. Additionally, or alternatively, there may also be arranged, in user's environments, one or more external sensors 204 such as cameras external to the device 202. For instance, cameras include security cameras associated with a home security system, traffic monitoring cameras, dash cameras, which can be privately owned and operated. Through the subscribed device association server 203, these cameras can communicate and exchange information, thereby potentially expanding a coverage of cameras in a form of a cameras network. These external sensors may be registered in a device association database 205 with respect to their locations and ranges of effective use.

In various embodiments, the device association server 203 may also have access to the device association database 205 in which database records may be created in order to register, track and report on the physical association between users and their devices including User 1 and the device 202.

FIG. 2B is a block diagram illustrating an example, non-limiting embodiment of a sensor registration stage in accordance with various aspects described herein. In various embodiments, an external sensor such as the external camera 203 is activated and a registration of the external camera 203 takes place in the device association server 204. A record of the external camera 203 is stored in an externals sensor database 206 that is associated with the device association database 205. For instance, a sensor identification (ID), a physical location and a range that the external camera 203 can cover (i.e., a range of operational locations for the camera 203) are stored in the external sensor database.

Additionally, the device association server 204 may query external cameras based on their location information in order to obtain information relevant to a specific location. Additionally or alternatively, the record 206 may include other indicators such as a status of the sensor, a type of the sensor, etc. in order to determine what type of sensor data may be collected and reported by the external sensor.

FIG. 2C is a block diagram illustrating an example, non-limiting embodiment of a device registration stage in accordance with various aspects described herein. In various embodiments, a device registration process follows the sensor registration as depicted in FIG. 2B. For instance, the device 202 may be registered via the device association application 210 and the device association server 204. Users can use the device association application 210 running on user devices to use the device association service. In some embodiments, the device association application 210 can be a part of operating systems for mobile devices which are provided by mobile devices manufacturers. The device association application 210 is configured to dynamically update the record stored in the device association database 205 by tracking User 1′ usage of the device 202.

A record of the device 202 includes a unique device ID which is associated with the device 202 and a device address. The device 202 may also, through the device association application 210, continually update a device physical location and include it in the record.

FIG. 2D is a block diagram illustrating an example, non-limiting embodiment of a device-user physical association stage including a tangible association in accordance with various aspects described herein. In various embodiments, the device association app 210 may be in communication with operating systems of the device 202 such that it may be able to receive updates that correspond to User 1's use of the device 202. In one embodiment, whenever User 1 touches the device 202, a record of the touch event may be detected and sent as a notification to the device association app 210. In the device association database 205, a record of the physical association (i.e., the touch event) between the user and the device 202 may be stored as a TOUCH type of association (208) in the record. This touch may be detected by one or more touch sensors among the on-board sensors 209 on the device 202.

In various embodiments, the touch event may be recorded to store a last touch event. Additionally or alternatively, every touch event may be recorded and in that case, the touch event may be recorded along with a time stamp (208). The association status is continuously updated such that a last occurrence of the physical association is stored in the device association database 205. The touch event may be recorded as a session where User 1 continuously touches the device 202 by scrolling the device 202 for a predetermined time period, such as 30 minutes. Then the touch event is recorded as a session of 30 minutes, instead of recording every touch event. The device association application 210 can be configured to track and transmit the touch event in various different ways such as tracking each and every touch event, tracking a latest touch event only, tracking a session involving continuous touches by User 1, etc.

Additionally or alternatively, the device 202 may be equipped with one or more sensors on board that are able to detect that User 1 is wearing the device 202. In that case, a record of the physical association between the user and the device 202 may be stored as a “WORN” type of association. For example, if the device 202 is a smart watch, sensors may be used to detect whether the smart watch is being worn, using techniques available in the pertinent art. The device 202 recorded as the “WORN” type of association may include various wearables that can detect a constant contact relationship between users and various wearables. Wearable devices are used to record and send worn states to the device association database 205.

Moreover, the sensors may detect unique biometric markers for User 1 such that it is known, not only that the device 202 is being worn, but moreover, that the device 202 is being worn by a specific user in question (i.e., User 1). For example, the on-board sensors 209 may collect biometric data and compare it with known biometrics, such as vein patterns, body heat signatures, odor signatures, or other indicators that uniquely identify User 1. This ensures that the identity of User 1 is verified as a specific user who had the last device association and when assistance is rendered for User 1 based on the device association, the assistance is provided to the user who last wore the device 202. The identity of User 1 can be verified at the device level or at the device association server 204.

In various embodiments, the onboard sensors 209 of the device 202 as depicted in FIG. 2D may also be used to predict whether the device 202 is being carried by the user. This type of physical association, i.e., a “CARRY” type of physical association, may be either for the case where the User 1 is in motion, and the device 202 is physically associated with the User 1, or whether the User 1 is relatively stationary.

In the “CARRY” type of physical association, the device 202 may not be a wearable device and instead, physically carried by User 1 in various ways with various mechanism or tools (e.g., a pocket, a bag, an arm band, a waist band, etc.). The onboard sensors 209 may collect data, such as ambient temperature and ambient light in the environment immediately surrounding the device 202 to predict, for example, whether the device 202 is in a User 1's pocket, or in a container that the User 1 is carrying such as a purse. Any number of different algorithms may be used to calculate this prediction, but in any case, the approach is to use the device 202's ability to detect its immediate ambient conditions (e.g., dark, bright, open, closed, etc.) and its motion (e.g., in transit or stationary), so as to predict with a level of confidence whether the device 202 is physically associated with User 1. The level of confidence that the device 202 is physically associated with a specific user in question may be able to increase if a carry association probability is detected immediately after a known association with the specific user. Appropriate artificial intelligence/machine learning (AI/ML) algorithms can be used to determine the level of confidence by the device 202. The AI/ML algorithms can be loaded onto the device 202 to interact with or be integrated with the device association application 210.

Additionally, the device 202's ability to detect its immediate ambient conditions and its motion can be used to indicate situations where the device 202 is stolen or lost and used by a person who is not a proper owner of the device 202. User 1 may develop certain patterns of using the device 202 in the same environments or the same usage patterns such as walking in a park around the same time of a day, commuting to the same location repeatedly (e.g., commuting to home address), etc. Different locations and/or different motions along with different usage patterns, detected by the device 202 and inconsistent with the predictions by the device 202, may lead to a determination that the device 1 is used by a person other than User 1. In that case, the level of confidence that the device is physically associated with User 1 can be very low. In some embodiments, a threshold level of confidence may be predetermined and set in order to trigger a notification or a warning message.

With respect to the touch, worn and carry types of physical association described above, the device 202 can be configured to define each type of physical association and associate events with each type of physical association. The configuration of appropriate logics in the device 202 can be modified and updated as needed. The configuration of appropriate logics in the device 202 may be determined based on the device information. For instance, the worn type of physical association may be configured to be added for wearable devices and deactivated for non-wearable devices.

In various embodiments, a type of physical association further includes a “SPEECH” type of physical association. A microphone sensor on board the device 202 may be used to detect a User 1's speech, for example, as it relates to User 1's use of an application on the device 202. The device 202 may further be capable of recognizing that the spoke utterance is that of a specific user in question by comparing the spoke utterance with known voice prints of User 1 that have been previously stored on the device 202. The known voice prints of User 1 may be associated the true identity of User 1. Therefore, a last spoken association of the specific user (e.g., User 1) with the device 202 may be detected by the device association app 210 and sent and recorded in the device association database record as a physical association between User 1 and the device 202. Additionally, or alternatively, a comparison between the last spoken association of User 1 and voice prints of User 1 can be done at the device 202 or the device association server level.

FIG. 2E is a block diagram illustrating an example, non-limiting embodiment of a device-user physical association including a facial association in accordance with various aspects described herein. In various embodiments, a camera on the device 202 may be used to detect User 1's known face print in association with User 1's use of an application on the device. For instance, the device 202 may use a face recognition in order to authenticate User 1 and allow User 1 to use the device 202. Therefore, the device association application 210 may detect this recognition of User 1's face and send it, in a similar manner, to record a last known facial association (211) between the device 202 and the user 1 in the device association database 205.

Additionally or alternatively, external sensors, such as the external camera 203 that is registered, may be used, instead of or in conjunction with the onboard sensors 209 of the device. For example, the external camera may detect User 1 in the location of the device 202 and record this physical association in the device association database 205. This is accomplished by the external camera 203 detecting that the device 202 is located within its range, and using its own location of where capabilities and its own sensors, such as LiDAR sensors, to detect the location of an object, in this case, User 1, in proximity to the range of operation of sensors. That is, the camera 203 may detect that User 1 is at a location and then compare that location to the location of the device 202. Further, by comparing known data of User 1, such as a face print, with the detected data, such as an image of the located user, the camera 203 can provide data such that the device association server 204 may conclude that User 1 is physically at the same location of the device 202, and a record of the physical association (i.e., the FACIAL type of association) is made in the database.

FIG. 2F is a block diagram illustrating an example, non-limiting embodiment of an association context in accordance with various aspects described herein. In various embodiments, when the association status is recorded, the device location at the time of the record update is also noted. As described above, the association type includes TOUCH, WORN, CARRY, SPEECH, FACIAL, etc. In each case where the association type is recorded under an association status field, the device location at the time of the record update is also noted. Therefore, the last known physical association between the device 202 and User 1 also contains context 220 of that association. The context 220 related to the user and device association may be recorded, as depicted in FIG. 2F. For example, if User 1 was using a specific application on the device 202 at the time of the physical association, that association reason as a separate data field may be recorded.

FIG. 2F depicts that the association reason is “911 call” by way of example. As another example, User 1 may have been using the device 202 to communicate with another user or to use another specific application on the device 202. As more examples, User 1 is using a facial recognition to have access to the device 202, calling a virtual agent operating on the device 202 using speech, etc.

FIG. 2G is a block diagram illustrating an example, non-limiting embodiment of a query/response for association status in accordance with various aspects described herein. In various embodiments, as User 1's physical association with the device 202 is known and recorded (e.g., FACIAL under the Association Status data field), the device 202 may therefore act as a true proxy of the location of User 1 at the time of the last recorded physical association. Therefore, for example, this information may be provided as useful information to another trusted user, such as a friend or family member or an emergency responder. This sharing of information (i.e., the location of User 1) may be accomplished by User 1 opting in to have the device association provided to specific trusted users upon request. The trusted users may, for example, query the device association database 205 using their own device association applications and querying for the location of User 1 based on the user ID. Accordingly, the trusted users can locate User 1 in emergency situations involving User 1 such as fire, missing for an extended period of time, a medical/health condition, etc. As depicted in FIG. 2G, a notification can be sent to the trusted users from the device association server 204, such as “VICTIM WAS CONFIRMED TO BE ON THE 4^{TH} FLOOR IN THE SOUTH HALLWAY 3 MINS AGO.” The sharing of User 1's location information this way will highly likely help first responders or a fire crew to locate User 1 in emergency situations and potentially can take life saving measures. The location sharing should be maintained and enforced in light of privacy concern and potential misuse of the user location information. In addition to User 1's specific permission, appropriate security and authentication/authorization measures should be taken in association with the sharing of the user location information.

FIG. 2H depicts an illustrative embodiment of a method 230 in accordance with various aspects described herein. In various embodiments, the method 230 includes establishing a device association database (Step 232), registering a target user device in the device association database (Step 234), receiving physical association detection data between a target user and the target user device (Step 235), recording the physical association detection data in an association status field of the device association database (Step 236); receiving a query regarding a location of the target user (Step 237), and generating a response to the query including the location of the target user device recorded in the device association database as the location of the target user (Step 238).

In various embodiments, the recording (Step 236) further includes recording the physical association detection data including a type of physical association and a timestamp of the physical association. The type of physical association comprises one of touch, worn, carry, speech and facial. The generating the response (Step 238) further includes generating the response including the response including a last location of the target user device, based on the timestamp of the physical association recorded in the device association database, as the location of the target user. The method 230 further includes storing a context of the physical association detection data between the target user and the target user device in an association reason field of the device association database. The receiving physical association detection data (Step 235) further includes receiving the physical association detection data from a device association application running on the target user device. The method 230 further includes receiving data indicative of the context of the physical association detection data from the device association application.

In various embodiments, the method 230 further includes receiving a request to share association status information with a group of trusted users from the target user, determining that the association reason field is indicative of an emergency event, and transmitting, to the group of trusted users, a last location of the target user device, recorded in the device association database, as the location of the target user. The group of trusted users include an emergency crew.

In various embodiments, the method 230 includes registering an external sensor in the device association database. The external sensor is arranged in a location facilitating to sense information about the target user. The method 230 further includes utilizing the location of the external sensor in generating the response to the query including the location of the target user device recorded in the device association database as the location of the target user and utilizing the sensing information about the target user by the external sensor to authenticate the target user.

In various embodiments, the method 230 includes registering a first type of user device including a location thereof and a second type of user device including a location thereof, respectively, in a device association database, and receiving first physical association detection data between a first user and the first type of user device and second physical association detection data between a second user and the second type of user device. The method 230 further includes storing the first physical association detection data and the second physical association detection data in a device association database, where the storing the first physical association detection data includes a first user identification, the location of the first type of user device, a first association status, a first user device address, wherein the first association status comprises one of a touch status, a carry status, a speech status and a facial status, and storing the second physical association detection data including a second user identification, the location of the second type of user device, a second association status, a second user device address, wherein the second association status comprises one of the touch status, the carry status, the speech status, the facial status and a worn status, and wherein the second type of user device is a wearable device.

In various embodiments, the method 230 further includes communicating with a device association application running on the first type of user device, and receiving, from the device association application, one or more touch detections of the first type of user device by the first user. The storing further includes storing every touch detection by the first user or a last touch detection by the first user. The method 230 further includes communicating with a device association application running on the second type of user device, receiving, from the device association application, one or more facial detections of the second type of user device by the second user, and communicating with an image sensor arranged proximate to the second user and receiving sensing information about the second user, wherein the image sensor is positioned external to the second type of user device.

In various embodiments, the method 230 further includes communicating with a device association application running on the first type of user device, receiving, from the device association application, one or more carry state detections of the first type of user device by the first user, and receiving, from onboard sensors of the first type of user device, a prediction indicative of an environment surrounding the first type of user device with a level of confidence, utilizing an artificial intelligence/machine learning (AI/ML) model. The method 230 further includes communicating with a device association application running on the second type of user device, receiving, from the device association application, a worn state detection of the second type of user device by the second user, and receiving, from the second type of user device, biometric information of the second type of user device to authenticate the worn state detection by the second user. The method 230 further includes communicating with a device association application running on the first type of user device, receiving, from the device association application, one or more speech detections by the first user, and storing a voice print of the first user in the first type of user device or the device association database.

FIG. 2I depicts an illustrative embodiment of another method 240 in accordance with various aspects described herein. The method 240 include configuring a device association database to record a device ID, a user ID, a device location, a physical association status between a user and a device, and a device address (Step 242), receiving, from a device association application running on the device, physical association detection data between the user and the device (Step 244), dynamically updating the physical association status along with a timestamp updated with the receiving of the physical association detection data (Step 246), and based on the recorded physical association status, transmitting the device location recorded in the device association database as a user location (Step 248).

In various embodiments, the method 240 includes receiving a query regarding the user location, and generating a response to the query including a last device location, based on the timestamp of the physical association status recorded in the device association database, as the user location. The configuring (Step 242) further includes configuring the device association database to record a context of the physical association status between the user and the device in an association reason field. The method 240 includes receiving, from the user, a request to share association status information with a group of trusted users, determining that the association reason field is indicative of an emergency event, and transmitting to the group of trusted users, a last location of the device, recorded in the device association database, as the user location, wherein the group of trusted users include an emergency crew and other users designated by the user.

In various embodiments, the method 240 further includes configuring the device association database to record an external sensor ID, a location of an external sensor, and an operation range of the external sensor, wherein the external sensor is arranged in a location capable of sensing information about the user, utilizing the location of the external sensor in generating the response to the query including the last device location as the user location, and utilizing the sensed information about the user by the external sensor to authenticate the user.

While for purposes of simplicity of explanation, the respective processes are shown and described as a series of blocks in FIGS. 2H-2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

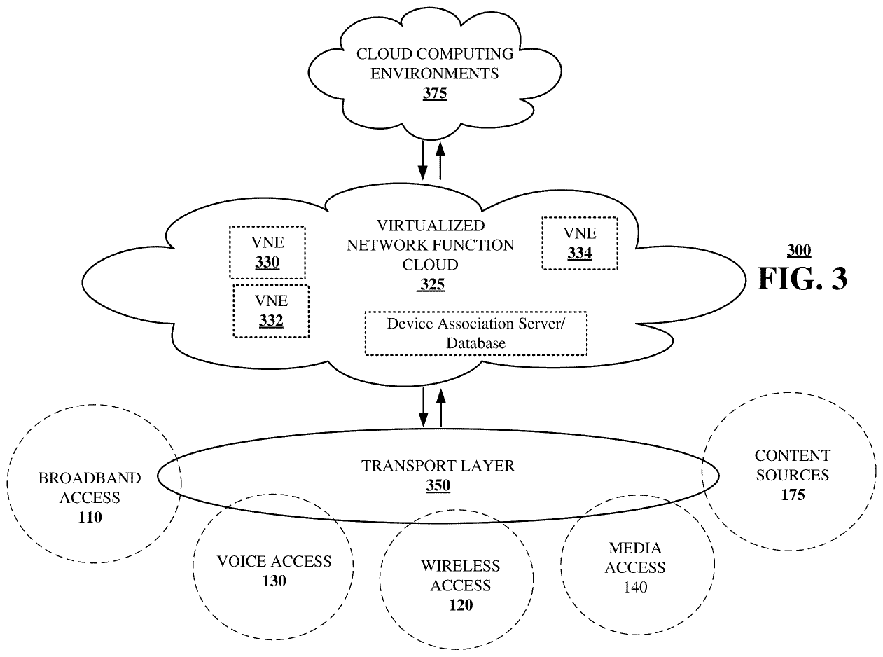

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230, 240 presented in FIGS. 1, 2H, 2I, and 3. For example, virtualized communication network 300 can facilitate in whole or in part user-to-device association tracking systems and methods.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

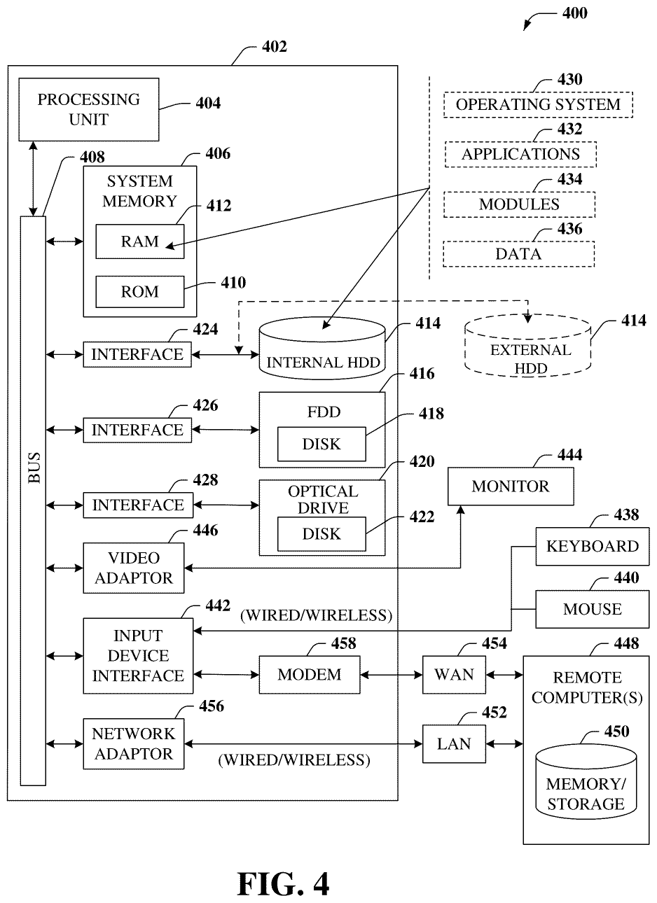

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part user-to-device association tracking systems and methods.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

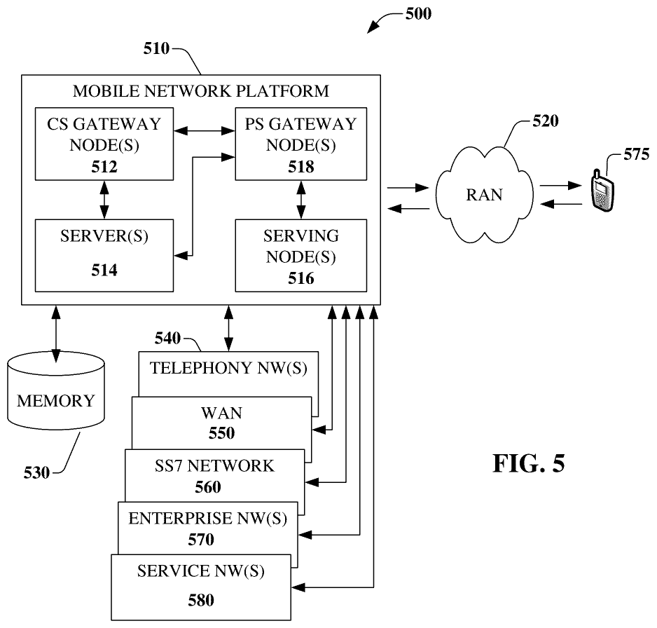

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part user-to-device association tracking systems and methods. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

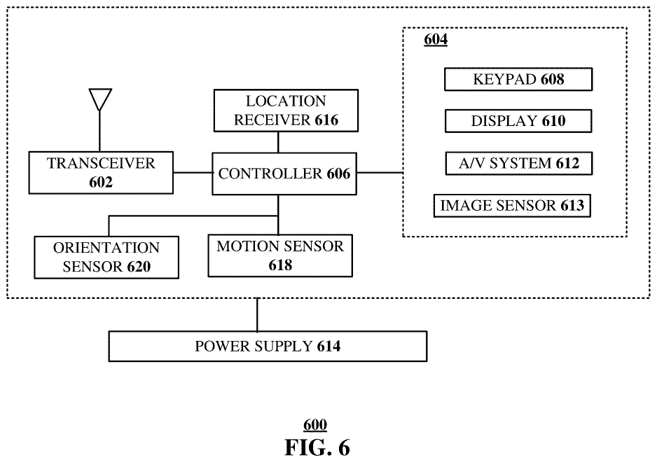

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part user-to-device association tracking systems and methods.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure.

The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
establishing, by a processing system including a processor, a device association database;
registering, by the processing system, a target user device in the device association database;
receiving, by the processing system, physical association detection data between a target user and the target user device;
recording, by the processing system, the physical association detection data in an association status field of the device association database;
receiving, by the processing system, a query regarding a location of the target user; and
generating, by the processing system, a response to the query including the location of the target user device recorded in the device association database as the location of the target user.

2. The method of claim 1, wherein the recording further comprises recording the physical association detection data including a type of physical association and a timestamp of the physical association.

3. The method of claim 2, wherein the type of physical association comprises one of touch, worn, carry, speech and facial.

4. The method of claim 2, wherein the generating the response further comprises generating the response including the response including a last location of the target user device, based on the timestamp of the physical association recorded in the device association database, as the location of the target user.

5. The method of claim 1, further comprising storing, by the processing system, a context of the physical association detection data between the target user and the target user device in an association reason field of the device association database.

6. The method of claim 5, wherein the receiving physical association detection data further comprises receiving the physical association detection data from a device association application running on the target user device; and
wherein the method further comprises receiving data indicative of the context of the physical association detection data from the device association application.

7. The method of claim 5, comprising:
receiving, by the processing system, a request to share association status information with a group of trusted users from the target user;
determining, by the processing system, that the association reason field is indicative of an emergency event; and
transmitting, by the processing system, to the group of trusted users, a last location of the target user device, recorded in the device association database, as the location of the target user, wherein the group of trusted users include an emergency crew.

8. The method of claim 1, comprising:
registering, by the processing system, an external sensor in the device association database, wherein the external sensor is arranged in a location facilitating to sense information about the target user;
utilizing, by the processing system, the location of the external sensor in generating the response to the query including the location of the target user device recorded in the device association database as the location of the target user; and
utilizing, by the processing system, the sensing information about the target user by the external sensor to authenticate the target user.

9. A device, comprising:
a processing system including a processor; and
a memory that stores executable instructions that, when executed by the processing system, facilitate performance of operations, the operations comprising:
registering a first type of user device including a location thereof and a second type of user device including a location thereof, respectively, in a device association database;
receiving first physical association detection data between a first user and the first type of user device and second physical association detection data between a second user and the second type of user device;
storing the first physical association detection data and the second physical association detection data in a device association database;
providing, by the processing system, the location of the first type of user device recorded in the device association database as the location of the first user; and
providing, by the processing system, the location of the second type of user device recorded in the device association database as the location of the second user.

10. The device of claim 9, wherein the storing further comprises:
storing the first physical association detection data including a first user identification, the location of the first type of user device, a first association status, a first user device address, wherein the first association status comprises one of a touch status, a carry status, a speech status and a facial status; and
storing the second physical association detection data including a second user identification, the location of the second type of user device, a second association status, a second user device address, wherein the second association status comprises one of the touch status, the carry status, the speech status, the facial status and a worn status, and wherein the second type of user device is a wearable device.

11. The device of claim 9, wherein the operations further comprise:
communicating with a device association application running on the first type of user device; and
receiving, from the device association application, one or more touch detections of the first type of user device by the first user; and
wherein the storing further comprises storing every touch detection by the first user or a last touch detection by the first user.

12. The device of claim 9, wherein the operations further comprise:
communicating with a device association application running on the second type of user device;
receiving, from the device association application, one or more facial detections of the second type of user device by the second user; and
communicating with an image sensor arranged proximate to the second user and receiving sensing information about the second user, wherein the image sensor is positioned external to the second type of user device.

13. The device of claim 9, wherein the operations further comprise:
communicating with a device association application running on the first type of user device;
receiving, from the device association application, one or more carry state detections of the first type of user device by the first user; and
receiving, from onboard sensors of the first type of user device, a prediction indicative of an environment surrounding the first type of user device with a level of confidence, utilizing an artificial intelligence/machine learning (AI/ML) model.

14. The device of claim 9, wherein the operations further comprise:
communicating with a device association application running on the second type of user device;
receiving, from the device association application, a worn state detection of the second type of user device by the second user; and
receiving, from the second type of user device, biometric information of the second type of user device to authenticate the worn state detection by the second user.

15. The device of claim 9, wherein the operations further comprise:
communicating with a device association application running on the first type of user device;
receiving, from the device association application, one or more speech detections by the first user; and
storing a voice print of the first user in the first type of user device or the device association database.

16. A non-transitory machine-readable medium, comprising executable instructions that, when executed by a processing system including a processor, facilitate performance of operations, the operations comprising:
configuring a device association database to record a device ID, a user ID, a device location, a physical association status between a user and a device, and a device address;
receiving, from a device association application running on the device, physical association detection data between the user and the device;
dynamically updating the physical association status along with a timestamp updated with the receiving of the physical association detection data; and
based on the recorded physical association status, transmitting the device location recorded in the device association database as a user location.

17. The non-transitory machine-readable medium of claim 16, wherein the operations further comprise:
receiving a query regarding the user location; and
generating a response to the query including a last device location, based on the timestamp of the physical association status recorded in the device association database, as the user location.

18. The non-transitory machine-readable medium of claim 16, wherein the configuring further comprises configuring the device association database to record a context of the physical association status between the user and the device in an association reason field.

19. The non-transitory machine-readable medium of claim 18, wherein the operations further comprise:
receiving, from the user, a request to share association status information with a group of trusted users;
determining that the association reason field is indicative of an emergency event; and
transmitting to the group of trusted users, a last location of the device, recorded in the device association database, as the user location, wherein the group of trusted users include an emergency crew and other users designated by the user.

20. The non-transitory machine-readable medium of claim 17, wherein the operations further comprise:
configuring the device association database to record an external sensor ID, a location of an external sensor, and an operation range of the external sensor, wherein the external sensor is arranged in a location capable of sensing information about the user;
utilizing the location of the external sensor in generating the response to the query including the last device location as the user location; and
utilizing the sensed information about the user by the external sensor to authenticate the user.
